(19) United States
(12) Patent Application Publication
(10) Pub. No.: US 2007/0179080 A1
(43) Pub. Date: Aug. 2, 2007

(54) Easy dispersible concentrrate ester quat compositions

(76) Inventors: Manlio Gallotti, Sao Paulo (BR); George Nunes, Sao Paulo (BR); Gustavo Kume, Sao Paulo (BR); Cesar Morales, Naucalpan (MX)

Correspondence Address: CLARIANT CORPORATION;INTELLECTUAL PROPERTY DEPARTMENT, 4000 MONROE ROAD, CHARLOTTE, NC, 28205, US

(21) Appl. No.: 10/594,210

(22) PCT Filed: Mar. 22, 2005
(86) PCT No.: PCT/EP05/03004

§ 371 Date: Apr. 4, 2007

(30) Foreign Application Priority Data
Mar. 29, 2004 (EP) 04007510.3

(51) Int. Cl. C11D 3/00

(52) U.S. Cl. 510/504

(57) ABSTRACT

The invention relates to an ester quat concentrate suitable for production of fabric softeners at lower temperatures comprising a) an esterquat compound; b) an organic solvent; c) water; d) a pH modifier. Although the presence of water in an ester quat concentrate is generally avoided due to the latter well known instability towards hydrolysis reaction, in the present invention, water is essential to the dispersibility at lower temperatures, which consequently leads to a significant increase in the final product viscosity. One way to solve this problem is by keeping the hydrolysis under control through the addition of a pH modifier.

This invention relates to an ester quat composition that is used for production of fabric softeners at lower temperatures, when compared to conventional process.

It is well known that textiles which have been washed, either in automatic or manual washing processes, and particularly those made of cellulose fibers, present a very unpleasant touch after drying. This undesired hardened feel can be overcome by treating the garments after washing in a rinsing bath with cationic compounds which contain two long aliphatic radicals in the structure.

Based on this thought, current commercial fabric softeners available in the market are still basically composed by a dispersion of dialkylic cationic substances, most of them, dialkyldimethyl ammonium salts and diester quats of triethanolamine, diethanolamine or glycerine.

The dispersion of cationic compounds, mainly those suitable for the application in fabric softeners, is a hard task to be achieved at around room temperature, due to the poor solubility/dispersibility of these raw material in cold water.

The present invention discloses a new option for working with ester quats in the production of fabric softeners, basically consisting of a high concentrated ester quat composition dispersible in water at temperatures of about 35° C.

Due to their well-known instability towards hydrolysis reaction, ester quats are rarely formulated as concentrated products in the presence of water, especially when the resulting composition is subjected to storage before final application. However, in the present patent, all advantages of water/ester quat association, which promotes the easy dispersibility of the final mixture, can be explored, as hydrolysis is particularly kept under control by the presence of a selected pH modifier.

In general, ester quats present problems concerning the production of viscous softeners, obliging the use of thickeners to achieve a high viscosity in the final product. A significant increase in the viscosity of softener formulations is another interesting advantage that comes from the dispersion, at lower temperatures, of the composition disclosed herein, which allows a expressive reduction or even the complete removal of thickeners from final formulations. This characteristic is especially important for some countries, more frequently in Latin America and Asia, where consumers still relate the good quality of a product to its high viscosity.

An ester quat concentrate, with 75-95% of active content and ethanol and/or glycols up to 100%, is claimed in EP 0 902 008. In that patent, a cosmetic final formulation, specifically prepared from the concentrate, is also claimed, but for being a final product, the minimum amount of water required is above the maximum tolerated in the present invention, and the addition of any other additive to keep hydrolysis under control is not mentioned. In U.S. Pat. No. 5,811,385, concentrated aqueous solutions of ester quat suitable for preparing laundry detergents and cosmetics are disclosed. No organic solvents are present in these concentrated aqueous solution. U.S. 2003 158 068 discloses fabric conditioning compositions based on ester quats, with maximum total active content of 25%. In that document, an unsaturated fatty acid is always present as a viscosity stabiliser. Final aqueous softener compositions with maximum ester quat concentration of 30% are also claimed in EP 0 669 391. The invention disclosed herein regards to a high concentrate ester quat composition, with at least 50% of active matter, indicated as raw material, for easy production of commercial fabric softeners at reduced temperatures.

The purpose of this invention is to provide concentrated ester quat compositions which contain water and thus can easily be diluted even at lower temperatures. On the same time the detrimental influence of water causing hydrolysis of the ester quat is minimized by the addition of a so-called pH-modifier.

The invention relates to an ester quat composition essentially consisting of
a) at least 50% by weight of an ester quat compound of the formula 1 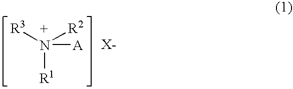
   wherein:
A is a group of the formulas —(CH₂)n—Q—T1 or 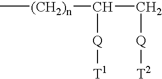
Q is selected from —O—C(O)—, —C(O)—O—;
R1 is (CH₂)n—Q—T2 or T3 or R3;
R2 is (CH₂)m—Q—T4 or T5 or R3;
R3 is H, C₁-C₆alkyl, C₂-C₆ alkenyl or C₁-C₆ hydroxyalkyl;
T1, T2, T3, T4, T5 are independently C₈-C₂₂-alkyl or C₈-C₂₂-alkenyl;
n and m are integers from 1 to 6; and
X is an anion, such as chloride, bromide, iodide, fluoride, sulfate, methylsulfate, hydrogensulfate, carbonate, hydrogencarbonate, phosphate, mono- and di-hydrogenphosphate, pyrophosphate, metaphosphate, nitrate, phosphonate, methylphosphonate, methandisulfonate, methylsulfonate, ethylsulfonate, and other anions which are softener-compatible
b) an organic solvent,
c) water and
d) a pH modifier.

Preferred ester quat compounds of formula 1 are those wherein:
Q is —O—C(O)—;
R¹ is (CH₂)n—Q—T² or T³;
R² is (CH₂)m—Q—T⁴ or T⁵ or R³;
R³ is C₁-C₆-alkyl, especially methyl, C₂-C₆-alkenyl or C₁-C₆-hydroxyalkyl, especially hydroxyethyl;
T¹, T², T³, T⁴, T⁵ are independently C₈-C₂₂-alkyl or C₈-C₂₂-alkenyl;
n and m are 1 or 2.

Most preferred ester quats compounds are triethanolamine-diester quats and diethanolamine-diester quats that means compounds of the formula 1 wherein A, R¹ and R² are a group of the formula —CH₂CH₂OCO—T¹, R² in addition may be a group R³, R² and R³ being independently selected R³ and X being as defined under formula 1. All mentioned ester quat compounds may contain any kind of anion, which is compatible with the ester-quat, the preferred ones are chloride, bromide, acetate, lactate, sulfate, hydrogensulfate or methylsulfate.

The claimed composition may contain these cationic compounds in an amount of from 50 to 90%, more precisely from 65 to 75% by weight of the whole composition.
b) an organic solvent

In principle, suitable organic solvents are any mono- or polyhydric short alcohols. Preference is given to using alcohols having from 1 to 4 carbon atoms, such as methanol, ethanol, propanol, isopropanol, straight chain and branched butanol, glycerol and mixtures of said alcohols. Other preferred solvents are polyethylene glycols having a relative molecular mass below 2000. In particular, the use of polyethylene glycol having a relative molecular mass between 200 and 600 and in amounts up to 30% by weight, and of polyethylene glycol having a relative molecular mass between 400 and 600 in amounts from 5 to 30% by weight is preferred. Also the lower alkyl ether of ethyleneglycol, propyleneglycol, polyethyleneglycol and polypropyleneglycol can be used. Other suitable solvents are, for example, triacetin (glycerol triacetate), 1-methoxy-2-propanol, hexyleneglycol.

The claimed composition may contain these organic solvents or even mixture thereof in an amount of from 5 to 30%, more precisely from 15 to 25% by weight of the whole composition.
c) water

In the present invention, its presence in the concentrate is essential to the good dispersibility at low temperatures. Accordingly, water is present in an amount of from 5 to 20%, more precisely from 7 to 15% by weight of the whole composition.
d) a pH modifier

When using ester quats as cationic compounds, the presence of water in the concentrate is a real problem, as the ester bonds are broken through the hydrolysis process. The best way to avoid it is using a controlled dosage of a pH modifier to increase the pH and thus slowing the hydrolysis significantly.

The pH modifiers especially indicated to the present composition are amine compounds, especially those selected from the group of triethanolamine, monoethanolamine, ethylenediamine, dialkylamines, dialkyl methyl amines, ethoxylated alkyl amines and aminomethyl propanol.

The claimed composition may contain a pH modifier in an amount of from 0.1 to 3% by weight of the whole composition.

Depending on the intended use, the compositions according to the invention comprise, in addition to the mentioned compounds, additives and auxiliaries which are customary and specific in each case such as for example electrolytes, perfumes, perfume carriers, colorants, hydrotropes, antifoaming agents, polymeric or other thickening agents, opacifiers, and anti-corrosion agents.

The compositons according to the invention are notable for a good storage stability and for allowing a fabric softener production by dilution with water at around room temperature.

The compositions according to the present invention can be made by melting the ester quat compound and adding the organic solvent to the monter est quat. Water and pH-modifier are mixed separately and this mixture is added to the mixture of the est quat and the organic solvent, which mixture has been cooled down to approximately 40 to 50° C.

### EXAMPLES

1 ) Hydrolytic Stability of Easy-Dispersible Concentrate Ester Quat Compositions

The table below shows the benefits from the presence of a selected pH modifier on the hydrolysis of the Ester Quat Concentrate. The test was conducted at 35° C., which is one of the indicated temperatures for the dispersion of the product.

Percentual Acid Value Increase during Storage Test at 35° C.

| | after | after | after | after |
|---|---|---|---|---|
| | 1 week | 2 weeks | 3 weeks | 4 weeks |
| Ester Quat Concentrate | 31.1% | 39.0% | 48.0% | 60.7% |
| without pH modifier | | | | |
| Ester Quat Concentrate | 1.3% | 1.3% | 3.4% | 13.9% |
| with pH modifier | | | | |

The ester quat used in this test was C₁₆-C₁₈-Dialkenoyloxyethyl-hydroxyethyl-methyl-ammonium methylsulfate in isopropanol (90% a.m.). The pH modifier was triethanolamine (99%).

From the table, it is clear that the pH modifier plays a definitive role in keeping the hydrolysis under control during storage, mainly at higher temperatures.

2) Concentrate Composition (% by weight)
A) 80.00 C₁₆-C₁₈-Dialkanoyloxyethyl-hydroxyethyl-methyl-ammonium methylsulphate in isopropanol (90% a.m.) (Praepagen® TQ)
B) 10.00 Isopropanol (99.5%)
C) 0.72 Triethanolamine (99%)
D) 9.28 Water

Procedure
I. Heated A in order to get a molten material (approx. 50° C.), under stirring.
II. Added B, under stirring, and cooled to approximately 40° C. (mixture 1).
III. Mixed, in a separate recipient, C and D at room temperature (mixture 2).
IV. Added mixture 2 into mixture 1, under stirring at 40° C.
V. Stirred for approx. 5 minutes.

3) Concentrate Composition (% by weight)
A) 80.00 C₁₆-C₁₈-Dialkanoyloxyethyl-hydroxyethyl-methyl-ammonium methylsulphate in ethanol (85% a.m.) (Praepagen®) TQL-E)
B) 10.00 Ethanol
C) 0.68 Triethanolamine (99%)
D) 9.32 Water

Procedure
I. Heated A in order to get a molten material (approx. 60° C.), under stirring.
II. Added B, under stirring, and cooled to approximately 50° C. (mixture 1).
III. Mixed, in a separate recipient, C and D at room temperature (mixture 2).
IV. Added mixture 2 into mixture 1, under stirring at 50° C.
V. Stirred for approx. 5 minutes.

4) Concentrate Composition (% by weight)
A) 0.00 C₁₆-C₁₈-Dialkanoyloxyethyl-hydroxyethyl-methyl-ammonium thylsulphate in isopropanol (85% a.m.) (Praepagen® TQL)
B) 0.00 Isopropanol
C) 0.68 Triethanolamine (99%)
D) 9.32 Water

Procedure
I. Heated A in order to get a molten material (approx. 60° C.), under stirring.
II. Added, under stirring, and cooled to approximately 50° C. (mixture 1).
III. Mixed in a separate recipient, C and D at room temperature (mixture 2).
IV. Addedixture 2 into mixture 1, under stirring at 50° C.
V. Stirred approx. 5 minutes.

5) Concentrate Composition (% by weight)
A) 80.00 C₁6-C₁₈-Dialkanoyloxyethyl-hydroxyethyl-methyl-ammonium methylsulphate in isopropanol (90% a.m.) (Praepagen® TQ)
B) 15.00 Isopropanol
C) 0.72 Triethanolamine (99%)
D) 4.32 Water

Procedure
I. Heated A in order to get a molten material (approx. 50° C.), under stirring.
II. Added B, under stirring, and cooled to approximately 40° C. (mixture 1).
III. Mixed, in a separate recipient, C and D at room temperature (mixture 2).
IV. Added mixture 2 into mixture 1, under stirring at 40° C.
V. Stirred for approx. 5 minutes.

6) Concentrate Composition (% by weight)
A) 80.00 C₁₆-C₁₈-Dialkanoyloxyethyl-hydroxyethyl-methyl-ammonium methylsulphate in isopropanol (90% a.m.) (Praepagen® TQ)
B) 15.00 Isopropanol
C) 0.72 Aminomethyl propanol
D) 4.32 Water

Procedure
I. Heated A in order to get a molten material (approx. 50° C.), under stirring.
II. Added B, under stirring, and cooled to approximately 40° C. (mixture 1).
III. Mixed, in a separate recipient, C and D at room temperature (mixture 2).
IV. Added mixture 2 into mixture 1, under stirring at 40° C.
V. Stirred for approx. 5 minutes.

7) Concentrate Composition (% by weight)
A) 80.00 C₁₆-C₁₈-Dialkanoyloxyethyl-hydroxyethyl-methyl-ammonium methylsulphate in ethanol (90% a.m.) (Praepagen® TQ-E)
B) 10.00 Ethanol (99.5%)
C) 0.72 Triethanolamine (99%)
D) 9.28 Water

Procedure
I. Heated A in order to get a molten material (approx. 50° C.), under stirring.
II. Added B, under stirring, and cool to approximately 40° C. (mixture 1).
III. Mixed, in a separate recipient, C and D at room temperature (mixture 2).
IV. Added mixture 2 into mixture 1, under stirring at 40° C.
V. Stirred for approx. 5 minutes.

8) Softener Formulations

The table below shows some comparative viscosity results between softeners prepared with an ester quat (Praepagen TQ), as normally available in the market, and with the Ester Quat Concentrate according to the present invention.

| | 3.5% a.m. | 3.5% a.m. | 7.0% a.m. |
|---|---|---|---|
| | without | with 1.0% | without |
| | thickener | thickener | thickener |
| Ester Quat (Praepagen TQ) | 5 | 215 | 105 |
| (Procedure 1) | | | |
| Ester Quat Concentrate | 230 | 685 | 830 |
| (Procedure 2) | | | |

Viscosity (cP) - Brookfield DV-II, 20 rpm, 25° C., spindle 3

The thickener used in the example above was a modified corn starch.

Procedures
Procedure 1—Hot Process using conventional ester quat (Praepagen TQ):
   A) Molten the ester quat (Praepagen TQ) at approx. 65° C.
   B) Mixed the water and thickener (when present) and heated to approx. 70° C.
   C) Added the ester quat (Praepagen TQ) to the water (or mixture with thickener), under stirring.
   D) Stirred for 45 minutes under cooling.
Procedure 2—Process with Reduced Temperatures
   A) Molten the Ester Quat Concentrate at approx. 35° C.
   B) Mixed the water and thickener (when present), at room temperature.
   C) Added the Ester Quat Concentrate to the water (or mixture with thickener), under stirring.
   D) Stirred for 30 minutes.

It is evident from the above given viscosity datas that an ester quat concentrate according to the present invention significantly increases the viscosity of the final softener composition as compared with a conventional ester quat.

1. An ester quat composition consisting essentially of:
a) at least 50% by weight of an ester quat compound of the formula 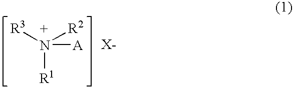
wherein:
A is a group of the formulas —(CH₂)ₙ—Q—T or 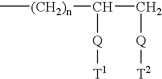
Q is —O—C(O)— or —C(O)—O—;
R¹ is (CH₂)ₙ—Q—T or T ³or R³;
R² is (CH₂)ₘ—Q—T⁴ or T⁵ or R³;
R³ is H, C₁-C₆-a]kyl, C₂-C₆-alkenyl or C₁-C₆-hydroxyalkyl;
T¹, T², T³, T⁴, T⁵ are independently C₈-C₂₂-alkyl or C₈-C₂₂-alkenyl;
n and m are integers from 1 to 6; and
X is an anion,
b) an organic solvent
c) water and
d) a pH modifier selected from the group consisting of triethanolamine, monoethanolamine, ethylenediamine, dialkylamine, dialkyl methyl amine, ethoxylated alkyl amine, methyl propanol alkyl amine, and mixtures thereof.

2. The concentrated ester quat composition as claimed in claim 1, wherein in the formula 1
Q is —O—C(O)—;
R¹ is (CH₂)ₙ—Q—T² or T³;
R² is (CH₂)m—Q—T⁴ or T⁵ or R³;
R³ is C₁-C₂-alkyl or C₁-C₆-hydroxyalkyl;
T¹, T², T³, T⁴, T⁵ are independently C₈-C₂₂-alkyl or C₈-C₂₂-alkenyl;
n and m are 1 or 2.

3. The concentrated ester quat composition of claim 1, wherein two or more different ester quat compounds of formula 1 are present.

4. The concentrated ester quat composition of claim 1, wherein the ester quat compound is a compound of formula 1 wherein A, R¹ and R² are a group of the formula —CH₂CH_{2OCO—T}¹, or wherein R² is R³, with the proviso that R² and R³ are different.

5. The concentrated ester quat composition of claim 1, wherein the ester quat compound is present in an amount of from 50 to 90% by weight of said concentrated ester quat composition.

6. The concentrated ester quat composition of claim 1, wherein the organic solvent is a short alcohol selected from the group consisting of methanol, ethanol, propanol, isopropanol, and mixtures thereof.

7. The concentrated ester quat composition of claim 1, wherein the organic solvent, or a mixture of organic solvents, is present in an amount of from 5 to 30% by weight of said concentrated ester quat composition.

8. The concentrated ester quat composition of claim 1 as claimed in any of the previous claims, wherein the water is present in an amount of from 5 to 20% by weight of said concentrated ester quat composition.

9. The concentrated ester quat composition of claim 1, wherein the pH modifier is present in an amount of from 0.1 to 3% by weight of the concentrated ester quat composition.

10. The concentrated ester quat composition of claim 1, which additionally contains any other additives or auxiliaries.

11. The concentrated ester quat composition of claim 1, wherein the ester quat compound is present in an amount of from 65 to 75% by weight of said concentrated ester quat composition.

12. The concentrated ester quat composition of claim 1, wherein the organic solvent, or a mixture of organic solvents, is present in an amount of from 15 to 25% by weight of said concentrated ester quat composition.

13. The concentrated ester quat composition of claim 1, wherein water is present in an amount of from 7 to 15% by weight of said concentrated ester quat composition.
